(19) United States
(12) Patent Application Publication
(10) Pub. No.: US 2026/0005342 A1
(43) Pub. Date: Jan. 1, 2026

(54) Secondary Battery

(71) Applicant: Samsung SDI Co., Ltd., Yongin-si (KR)

(72) Inventor: Taewoong Jang, Yongin-si (KR)

(73) Assignee: Samsung SDI Co., Ltd., Yongin-si (KR)

(21) Appl. No.: 18/899,536

(22) Filed: Sep. 27, 2024

(30) Foreign Application Priority Data
Jun. 27, 2024 (KR) 10-2024-0084696

(51) Int. Cl. H01M 50/14; H01M 10/04; H01M 50/107; H01M 50/152

(52) U.S. Cl. CPC H01M 50/14; H01M 10/0431; H01M 50/107; H01M 50/152

(57) ABSTRACT

The present disclosure relates to a secondary battery. The secondary battery includes: an electrode assembly configured to comprise a first electrode, a second electrode, and a separator disposed between the first electrode and the second electrode and wound therearound; a case configured to have an opening formed on one side thereof to accommodate the electrode assembly; and a cap assembly joined to the one side of the case to seal the opening of the case, and the case comprises a notch formed on a side portion of the case.

### CROSS-REFERENCE TO RELATED APPLICATIONS

This present application claims priority to and the benefit under 35 U.S.C. § 119(a)-(d) of Korean Patent Application No. 10-2024-0084696, filed on Jun. 27, 2024, in the Korean Intellectual Property Office, the entire disclosure of which is incorporated herein by reference.

### FIELD

Aspects of embodiments of the present disclosure relate to a secondary battery in which a notch is formed on an outer circumferential surface of a case.

### BACKGROUND

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Recently, as the demand for wearable devices such as wireless headphones or earphones, smart watches, and body-worn medical devices increases, there is an increasing demand for small secondary batteries with high energy density and sufficiently small size. For example, coin cells or button cells may be used as secondary batteries, the height of which is significantly smaller than the width, depending on the characteristics of usage environments.

Due to the very small size and the characteristics of case materials, conventional coin cells may cause significant cell deformation even with a slight external twist. For example, in a case where a great force is applied to one side of the case, electrical sparks may occur due to tearing of the case and jelly roll deformation, which increases the risk of fire. The intensity of electrical sparks increases as the short-circuit contact area, due to deformation of the case, decreases.

The above information disclosed in this Background section is for enhancement of understanding of the background of the present disclosure, and therefore, it may contain information that does not constitute related (or prior) art.

### SUMMARY

The present disclosure has been proposed to solve the above problems, and an object of the present disclosure is to provide a secondary battery in which a notch is formed on an outer circumferential surface of a case.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

In order to overcome at least one of the above aspects, a secondary battery according to embodiments of the present disclosure includes: an electrode assembly configured to include a first electrode, a second electrode, and a separator disposed between the first electrode and the second electrode and wound therearound; a case configured to have an opening formed on one side thereof to accommodate the electrode assembly; and a cap assembly joined to the one side of the case to seal the opening of the case, wherein the case comprises a notch formed on a side portion of the case.

The notch may be formed in a region of the side portion that corresponds to a side portion of the electrode assembly accommodated in the case.

The notch may be formed in a region of the side portion that corresponds to side portions of the first electrode and the second electrode disposed on an outermost side of the electrode assembly.

The notch may be formed in at least one position on an outer circumferential surface of the side portion.

The notch may be formed in a continuous region surrounding an outer circumferential surface of the side portion.

The notch may include a plurality of notches formed at a plurality of positions on a region surrounding an outer circumferential surface of the side portion.

The notch may be located in a location consisting of a range of ¼ of a total height of the case from a center of the side portion.

A cross section of the notch may have a semicircular shape.

A cross section of the notch may have a wedge shape.

The notch may be formed in a continuous region surrounding an outer circumferential surface of the side portion in an inclined shape.

A depth of the notch may be less than half a thickness of the side portion.

A charging capacity of the electrode assembly may fall within a range of 10 mAh to 150 mAh.

A diameter of the case may fall within a range of 9 mm to 14 mm.

A height of the case may fall within a range of 4.5 mm to 6 mm.

The notch may be configured to penetrate into an inside of the case in response to external pressure and come into contact with the first electrode or the second electrode.

The notch may be formed in a plurality of continuous regions surrounding an outer circumferential surface of the side portion.

In order to overcome at least one of the above aspects, a secondary battery according to other embodiments of the present disclosure includes: an electrode assembly configured to include a first electrode, a second electrode, and a separator disposed between the first electrode and the second electrode and wound therearound; a cylindrical case configured to have an opening formed on one side thereof to accommodate the electrode assembly; and a cap assembly joined to the one side of the cylindrical case to seal the opening of the case, wherein the notch is formed in a region of the side portion of the cylindrical case that corresponds to a side portion of the electrode assembly accommodated in the case.

The notch may be configured to penetrate into an inside of the case in response to external pressure and come into contact with the first electrode or the second electrode.

The notch may be formed in at least one position on an outer circumferential surface of the side portion.

The notch may be located in location consisting of a range of ¼ of a total height of the case from a center of the side portion.

### Advantageous Effects

According to various embodiments of the present disclosure, the notch may be formed along the outer surface of the case of the secondary battery. Accordingly, in a case where external pressure or impact is applied to the case, a short circuit may be induced between the case and the positive/negative electrode substrates, thereby quickly reducing the amount of current inside the cell.

According to various embodiments of the present disclosure, in a case where external pressure is applied to the case of the secondary battery, the case may collapse in the notch portion formed along the outer surface of the case, and a portion of the collapsed case penetrates into the inside of the electrode assembly. This may cause a short circuit between the negative electrode substrate and the positive electrode substrate on the outer portion of the electrode assembly. Accordingly, the amount of current within the cell may be quickly reduced in a case where external pressure is applied to the case.

According to various embodiments of the present disclosure, the amount of current within the cell may be quickly reduced in a case where external pressure is applied to the case of the secondary battery, thereby reducing the risk of explosion or fire that may occur in a case where the case is deformed or compressed.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1 illustrates an example of a secondary battery according to embodiments of the present disclosure.

FIG. 2 illustrates a cross-sectional view of a secondary battery according to embodiments of the present disclosure.

FIG. 3 illustrates a process of short-circuiting an electrode by penetrating into a case by external pressure according to embodiments of the present disclosure.

FIG. 4 illustrates a position of a notch according to embodiments of the present disclosure.

FIG. 5 illustrates a shape of a continuous notch formed on a side surface of a case of a secondary battery according to embodiments of the present disclosure.

FIG. 6 illustrates a shape of a discontinuous notch according to embodiments of the present disclosure.

FIG. 7 illustrates a shape of a multi-notch according to embodiments of the present disclosure.

FIG. 8 illustrates an inclined notch according to embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified. The terms used in the present specification are for describing embodiments of the present disclosure and are not intended to limit the present disclosure.

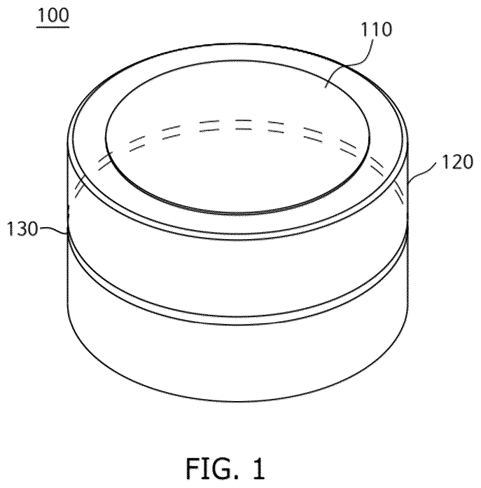

FIG. 1 illustrates an example of a secondary battery 100 according to embodiments of the present disclosure.

A secondary battery according to one or more embodiments is a micro-sized secondary battery and may be a coin cell or a button cell but is not limited thereto and may be a cylindrical or pin-type battery.

The coin cell or button cell is a battery in the form of a thin coin or button and may refer to a battery having a ratio of height to diameter (height/diameter) of 1 or less but is not limited thereto. Because the coin cell or button cell is generally cylindrical, the cross section in the horizontal direction is generally circular. However, the cross section in the horizontal direction is not limited thereto and may have an elliptical or polygonal shape. The diameter may refer to a maximum distance in the horizontal direction of the battery, and the height may refer to a maximum distance in the vertical direction of the battery (e.g., distance from the flat bottom surface to the flat top surface of the battery).

Referring to FIG. 1, the secondary battery 100 according to embodiments of the present disclosure may include a cap assembly 110 and a case 120.

The case 120 may have an opening formed at the upper portion so as to accommodate an electrode assembly. After the electrode assembly is inserted through the opening of the case 120, an electrode terminal of the cap assembly 110 may be electrically connected to a positive or negative electrode tab of the electrode assembly. Then, the cap assembly 110 may be closely connected to the end of the opening of the case 120 through a method such as welding, thereby sealing the opening of the case 120.

The case 120 may include a notch 130 formed on the outer surface of the case 120 in a shape surrounding the outer surface of the case 120. A portion of the case 120 where the notch 130 is formed may have a smaller thickness than that of other portions. The portion of the case 120 where the notch 130 is formed may include a recess that is recessed in a direction from the outer surface of the case to the inner surface of the case 120, unlike other portions that are substantially flat. For example, the notch 130 may be a recess formed in approximately a semicircular shape or a wedge shape, but the present disclosure is not limited thereto. In addition, FIG. 1 illustrates that the notch 130 is formed in a continuous ring shape along the outer surface of the case 120, but the present disclosure is not limited thereto. The notch 130 may include a plurality of recesses formed at discontinuous positions or regions along the outer surface of the case 120.

In a case where external pressure is applied to the secondary battery, the portion of the case 120 where the notch 130 is formed may be broken or deformed, and thus, the overall shape of the case 120 may be deformed. In a case where the notch 130 of the case 120 is broken, the upper end (or lower end) of the notch 130 may move toward the lower end (or upper end) thereof on the case 120, or the upper end or lower end may come into contact with the electrode of the electrode assembly accommodated in the case 120; otherwise, deformation of the electrode may be caused.

Accordingly, an outer portion of the case 120 collapses through fracture of the notch on the case 120, which may cause a short circuit in the electrode assembly. That is, the case 120 of the secondary battery to which external pressure is applied may collapse at the notch 130. For example, in a case where the secondary battery 100 is compressed by external pressure, the notch 130 formed along the side surface of the case 120 has lower strength than other portions, and thus, collapse of the case 120 may occur starting from the notch 130. As the case 120 collapses, a portion of the collapsed case 120 may penetrate into the electrode assembly inside the case 120. A portion of the penetrated case 120 may cause a short circuit between the negative electrode substrate and the positive electrode substrate on the outer portion of the electrode assembly. Accordingly, a short circuit of the electrode assembly may occur due to fracture or collapse of the notch 130 of the case 120, which may rapidly reduce the amount of current in the secondary battery to which external pressure is applied and may improve additional defects that occur in a circumstance where the case 120 is compressed. The detailed configuration and operation of the case 120 including the notch 130 will be described below.

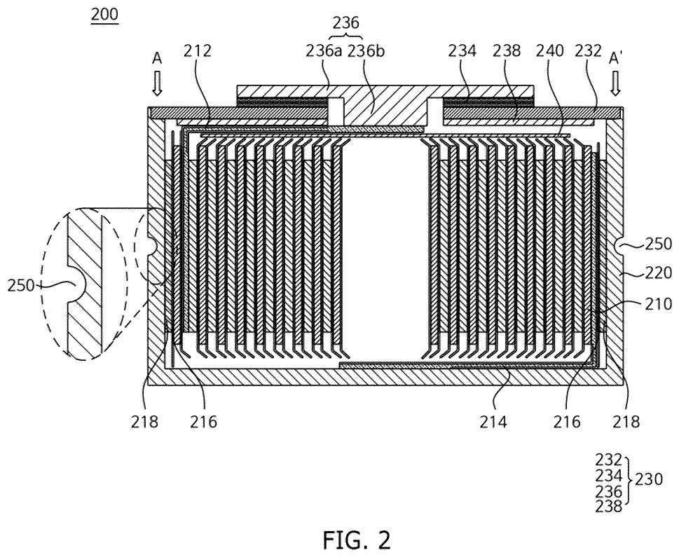

FIG. 2 illustrates a cross-sectional view of a secondary battery according to embodiments of the present disclosure. FIG. 2 may illustrate a cross-sectional view of the central portion of the secondary battery of FIG. 1 cut in the height direction. A secondary battery 200 may include an electrode assembly 210, a case 220, a cap assembly 230, and an insulating washer 240.

The secondary battery 200 may be a coin-type or button-type secondary battery. For example, the secondary battery may have a cylindrical shape. However, the secondary battery is not limited thereto and may be a cylindrical, prismatic, or pouch-type secondary battery.

The electrode assembly 210 may include a first electrode, a second electrode, and a separator. Specifically, the electrode assembly 210 may be configured by winding the separator disposed between the first electrode and the second electrode. The electrode assembly 210 may be wound to form a core portion and may include a through-hole in the core portion.

The first electrode may include a first substrate and a first active material layer located on the first substrate. A first electrode tab 212 may extend outwardly from a first uncoated portion of the first substrate where the first active material layer is not located, and the first electrode tab 212 may be electrically connected to a terminal plate 236 of the cap assembly 230.

The second electrode may include a second substrate and a second active material layer located on the second substrate. A second electrode tab 214 may extend outwardly from a second uncoated portion of the second substrate where the second active material layer is not located, and the second electrode tab 214 may be electrically connected to the case 220. The first electrode tab 212 and the second electrode tab 214 may extend in opposite directions.

In some embodiments, each of the first electrode tab 212 and the second electrode tab 214 may be covered with a cover tape. The cover tape may include an insulating material. The insulating material may provide electrical insulation to prevent current from passing therethrough. The cover tape may prevent a short circuit from occurring in the first electrode tab 212 and the second electrode tab 214.

The first electrode may function as a positive electrode. In this case, the first substrate may be composed of, for example, aluminum foil, and the first active material layer may include, for example, a transition metal oxide. The second electrode may function as a negative electrode. In this case, the second substrate may be composed of, for example, copper foil or nickel foil, and the second active material layer may include, for example, graphite.

The separator may function to prevent a short circuit between the first electrode and the second electrode while allowing movement of lithium ions. The separator may be composed of, for example, polyethylene film, polypropylene film, polyethylene-polypropylene film, or the like, but the present disclosure is not limited thereto.

Referring to FIG. 2, the first electrode tab 212 of the first electrode may be formed on one side of the electrode assembly 210. The second electrode tab 214 of the second electrode may be formed on the other side (than the one side) of the electrode assembly 210. However, the present disclosure is not limited thereto. For example, the first electrode tab and the second electrode tab may be formed on a same side of the electrode assembly 210.

The case 220 may accommodate the electrode assembly 210 and an electrolyte, and may configure the external appearance of the secondary battery together with the cap assembly 230. The case 220 may include an approximately cylindrical sidewall portion and a bottom portion connected to one side of the sidewall portion. The diameter of the case 220 may range from 9 mm to 14 mm. The height of the case 220 may range from 4.5 mm to 6 mm. However, the shape or size of the case 220 is not limited thereto, and the case 220 may be configured in various shapes such as a circular shape and a pouch shape, and various sizes. In addition, the case may be composed of metal such as aluminum, aluminum alloy, nickel-plated steel, or stainless steel (steel use stainless (SUS)), or a laminated film or plastic that constitutes the pouch.

The case 220 may accommodate the electrode assembly 210. The electrode assembly 210 may be inserted into the case 220 through an opening formed in one side thereof. In addition, the electrode of the electrode assembly 210 accommodated in the case 220 and the terminal plate 236 of the cap assembly 230 may be electrically connected to each other. Thereafter, the opening of the case 220 may be closed by the cap assembly 230. The cap assembly 230 may be joined to one side of the case 220.

The cap assembly 230 may include a cap plate 232, an insulating layer 234, a terminal plate 236, and an insulating member 238. The cap plate 232 may cover the opening of the case 220. The cap plate 232 may be joined to the side surface of the case 220 corresponding to the side surface of the opening.

An insertion hole may be formed in the cap plate 232. Specifically, the insertion hole may be formed at the center of the cap plate 232. The terminal plate 236 may be inserted into the insertion hole and the terminal plate 236 may be joined to the cap plate 232. The terminal plate 236 may include a body portion 236a and an insertion portion 236b protruding from the body portion 236a. The insertion portion 236b of the terminal plate 236 may be inserted into the insertion hole of the cap plate 232. In addition, the insertion portion 236b of the terminal plate 236 may be positioned in contact with the first electrode tab 212. Referring to FIG. 2, the cap assembly 230 including the terminal plate 236 may be joined to the case 220 so that the insertion portion 236b faces the electrode assembly.

The insulating layer 234 may be disposed between the terminal plate 236 and the cap plate 232. The insulating layer 234 has adhesive strength and thus may join the terminal plate 236 to the cap plate 232. The insulating layer 234 is composed of an insulating material and may electrically insulate the terminal plate 236 and the cap plate 232 from one another.

In some embodiments, the insulating member 238 may be disposed on the bottom surface of the cap plate 232. The top surface of the cap plate 232 may face the body portion 236a of the terminal plate 236, and the bottom surface of the cap plate 232 may face the electrode assembly 210. The insulating member 238 is composed of an insulating material and may insulate between the cap plate 232 and the electrode assembly 210 or between the cap plate 232 and the first electrode tab 212.

In some embodiments, the electrode assembly 210 may include a negative electrode substrate 216 surrounding the outer circumference. At this time, the negative electrode substrate 216 may be formed of the same material as the substrate of the second electrode. In other embodiments, the substrate of the second electrode in the electrode assembly 210 may be extended and wound to wrap around the outer circumference of the electrode assembly. In this circumstance, the substrate of the second electrode may be a negative electrode substrate.

In some embodiments, the electrode assembly 210 may include a sealing tape 218 that surrounds at least a portion of the outermost circumference of the electrode assembly 210. The sealing tape 218 may seal the wound electrode assembly 210. For example, in the electrode assembly 210, the winding of the first electrode, the second electrode, and the separator may be maintained without being unwound by the sealing tape 218. For example, the sealing tape 218 has adhesive strength and may be joined to at least a portion of the outermost circumference of the electrode assembly 210. The sealing tape may include an insulating material. For example, the sealing tape may include at least one of polyimides (PI), polyethylene (PE), and polystyrene (PS).

In some embodiments, the first electrode tab 212 may be bent under the terminal plate 236 in the case 220 in which the electrode assembly 210 is accommodated and the cap assembly 230 is joined. The bent first electrode tab 212 may be prevented from short-circuiting with the electrode assembly 210 by the insulating washer 240. The insulating washer 240 may be disposed between the electrode assembly 210 and the terminal plate 236. Specifically, the insulating washer 240 may be disposed between the electrode assembly 210 and the first electrode tab 212 located below the terminal plate 236. The insulating washer 240 may include an insulating material. The insulating washer 240 may space the first electrode tab 212 and the electrode assembly 210 apart from one another. In addition, the insulating washer 240 may electrically insulate the first electrode tab 212 and the electrode assembly 210 from one another.

A region where the case 220 and the cap assembly 230 are in contact with one another may be welded so that the case 220 and the cap assembly 230 are joined to one another. Referring to FIG. 2, the case 220 and the cap assembly 230 may be joined by welding in welding regions A and A′. The separator of the electrode assembly 210 may be longer in the height direction of the electrode assembly 210 than the first electrode and the second electrode. Due to the negative electrode substrate 216 surrounding the outer circumference of the electrode assembly 210, one end of the separator of the electrode assembly 210 may be distant from the welding regions A and A′. Similarly, due to the negative electrode substrate 216, the first electrode tab 212 of the electrode assembly 210 may be distant from the welding regions A and A′. Due to this, the separator may not be caught between the case 220 and the cap assembly 230 and may not be damaged from welding performed in the welding regions A and A′. In addition, the first electrode tab 212 may be damaged from the welding performed in the welding regions A and A′, which may be prevented along with a short circuit that may occur.

In some embodiments, the case 220 may include a notch 250 formed in a certain region surrounding the side surface thereof. The notch 250 may be deformed or broken in a case where external pressure is applied to the secondary battery, thereby allowing a portion of the case 220 to penetrate into the electrode assembly 210. Accordingly, a short circuit may occur between a portion of the case 220 and the electrode assembly 210 or between the electrodes of the electrode assembly 210. That is, the notch 250 may be configured to induce a portion of the case 220 to penetrate into the case 220 and contact the first electrode or the second electrode in response to external pressure.

The notch 250 may be formed on the side portion outside the case. The notch 250 may be formed to surround the outer circumferential surface of the side portion of the case 220. The notch 250 may be formed in a region of the side portion of the case 220 that corresponds to the side portion of the first electrode or the second electrode disposed on the outermost side of the electrode assembly 210. In a case where the notch 250 is fractured or collapsed and penetrates into the case, the first and second electrodes disposed on the outermost side of the electrode assembly may be short-circuited.

According to some embodiments, the cross section of the notch 250 may have a concave semicircular shape. In addition, the cross section of the notch 250 may have a sharp wedge shape that gradually becomes thinner or narrower in the direction of the surface close to the electrode assembly. The shape of the notch is not limited to the semicircular shape of the wedge shape and may also be a V-shape, a U-shape, a spherical shape, or an inverted trapezoidal shape. The depth of the notch 250 may be less than half the thickness of the side portion of the case 220. In a case where the depth of the notch 250 is more than half the thickness of the case 220, the overall strength of the case 220 may be weakened.

In a case where external pressure is applied to the secondary battery 200, the case 220 may be broken or collapsed at the notch 250. The notch 250 formed along the side surface of the case 220 has lower strength than other regions of the case 220 where the notch is not formed. Accordingly, in a case where external pressure is applied to the secondary battery, fracture may occur in the portion of the case 220 where the notch 250 is formed, or collapse may occur from the corresponding portion.

As the case 220 collapses due to fracture of the notch 250, etc., a portion of the collapsed case 220 may penetrate into the electrode assembly 210. A portion of the penetrated case 120 may cause a short circuit between the negative electrode substrate and the positive electrode substrate on the outer portion of the electrode assembly. Due to the configuration and operation of the notch 250, the amount of current in the secondary battery 200 to which external pressure is applied may be quickly reduced, thereby improving defects that occur in a circumstance where the secondary battery is compressed.

The charging capacity of the electrode assembly 210 may fall withing a range of 10 mAh to 150 mAh. Within such a charge capacity range, the notch 250 formed on the case 220 of the secondary battery 200 may be configured to induce safe thermal runaway. For example, the maximum charging capacity at which the notch formed on the case of the coin cell may be configured to induce safe thermal runaway may be calculated as follows.

The heat generation amount H in a case where a short circuit occurs between the electrodes of the electrode assembly in the secondary battery may be calculated by the following formula.

$$H ( cal ) = 0.24 * {I}^{2} * R * t \qquad [ Formula 1 ]$$

In a case where the charging capacity of the secondary battery is 150 mAh, this means that the secondary battery may use a current of 150 mA for 1 hour, that is, 3,600 seconds. In the secondary battery with such a charging capacity, it is assumed that the current is exhausted within 1 second due to a short circuit between the electrodes of the electrode assembly. At this time, the heat generation amount H due to the short circuit phenomenon may be calculated as follows.

$$H = 0.24 * {( 0.15 A * 3600 )}^{2} * ( 1 mohm ) * ( 1 second ) = 70 cal \qquad [ Formula 2 ]$$

For example, in a case where the secondary battery is used in an environment at room temperature of 25 degrees, the temperature within the case or the electrode assembly of the secondary battery may locally rise by about 70 degrees due to a short circuit according to the calculated value of the above formula. In this circumstance, because the temperature of the secondary battery is 95 degrees, the possibility of ignition is not high.

Meanwhile, in a circumstance where the charging capacity of the secondary battery is 200 mhA, the heat generation amount H due to the short circuit phenomenon may be calculated as follows.

$$H = 0. 24 * {( 0.2 A * 3600 )}^{2} * ( 1 mohm ) * ( 1 second ) = 124 cal \qquad [ Formula 3 ]$$

For example, in a circumstance where the secondary battery is used in an environment at room temperature of 25 degrees, the temperature within the case or the electrode assembly of the secondary battery may locally rise by about 124 degrees due to a short circuit according to the calculated value of the above formula. In this case, because the temperature of the secondary battery is 149 degrees, the possibility of ignition is high.

According to the formulae described above, in a circumstance where the charging capacity of the electrode assembly 210 is set to 150 mAh or less, the notch 250 formed on the case 220 of the secondary battery 200 is broken or collapsed, safe thermal runaway may be induced while suppressing the possibility of ignition even if a short circuit occurs in the electrode assembly, etc.

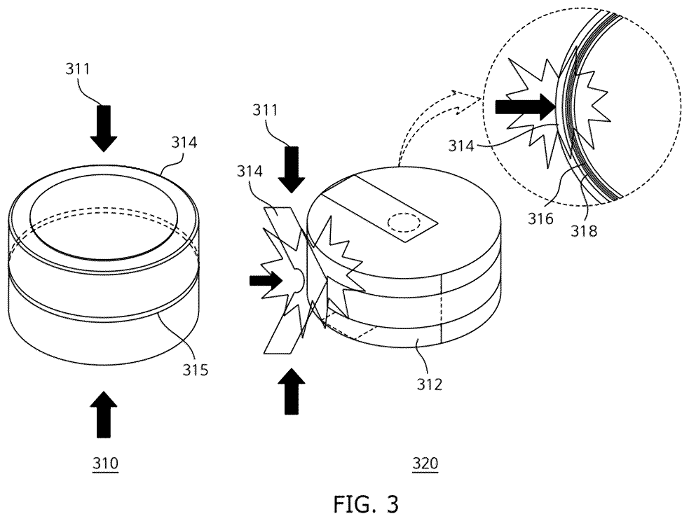

FIG. 3 illustrates a process in which a portion of the case penetrates into the electrode assembly and short-circuits the electrode in a case where the notch is broken or collapsed due to external pressure according to embodiments of the present disclosure.

As illustrated, external pressure may be applied to the secondary battery 310. The case 314 may collapse due to external pressure 311. Because the notch 315 formed along the side surface of the case 314 has lower strength than a portion of the case 314 where the notch is not formed, collapse may occur from the notch 315 in a case where external pressure is applied to the secondary battery.

A portion of the collapsed case 314 may penetrate into the case 314 (in embodiment 320 in the Figure). A portion of the collapsed case 314 may be in contact with the electrode assembly 312. A portion of the collapsed case 314 may penetrate toward the electrode assembly 312. A portion of the collapsed case 314 may short-circuit the positive electrode substrate 316 and the negative electrode substrate 318 located on the outer portion of the electrode assembly 312. The positive electrode substrate 316 and the negative electrode substrate 318 may be short-circuited, thereby quickly reducing the amount of current in the secondary battery. The notch 315 may quickly reduce the amount of current in the secondary battery to which external pressure is applied, thereby improving defects that occur in a case where the secondary battery is compressed.

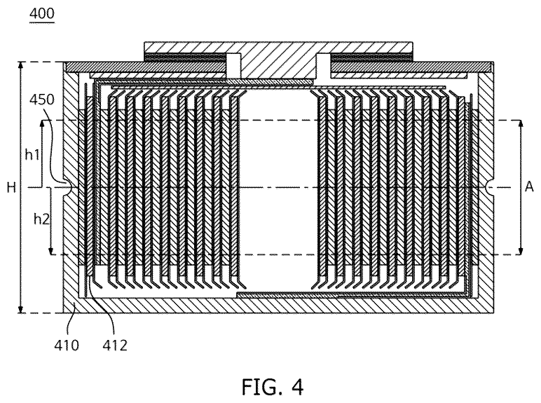

FIG. 4 illustrates a position of a notch according to embodiments of the present disclosure.

According to embodiments, a notch 450 formed on a side surface of a case 410 of a secondary battery 400 causes a case to collapse in the notch 450 in a case where external pressure is applied to the secondary battery 400, and the penetration into an electrode assembly inside the case may cause a short circuit in the electrode. To induce such a short circuit, the notch 450 may be formed in a region of the side portion of the case 410 that corresponds to the side portion of the electrode assembly 412 accommodated in the case 410. The notch 450 may be formed in a region of the side portion of the case 410 that corresponds to the side portion of the first electrode or the second electrode disposed on the outermost side of the electrode assembly 412.

In addition, the position of the notch 450 on the case 410 may be determined by considering the top/bottom bias of the electrode assembly 412 and the alignment of the positive and negative electrodes. Accordingly, the notch 450 may be formed within the range (h1, h2) of ¼ of the total height H of the case 410 from the midpoint on the side surface of the case 410. Typically, the total height of the coin cell is 4.5 mm to 6 mm. In this case, the notch 450 may be formed within a range from the midpoint on the side surface of the case 410 (i.e., a point of 2.25 mm to 3 mm from the bottom surface of the case 410) to a point of 1.1 mm to 1.5 mm below or above.

The region of the notch 450 that corresponds to the side portions of the first electrode and the second electrode disposed on the outermost side of the electrode assembly 412 is included in a range (h1, h2) of ¼ of the total height H of the case 410 at the midpoint on the side surface of the case 410. Accordingly, the range of the position A where the notch is formed may be expressed as follows.

$$0 \leq h 1 ( A ) \leq \frac{1}{4} H \qquad [ Formula 4 ]$$

$$0 \leq h 2 ( A ) \leq \frac{1}{4} H$$

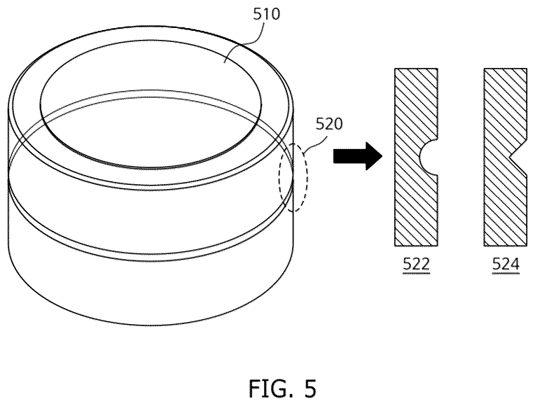

FIG. 5 illustrates a shape of a continuous notch formed on a side surface of a case of a secondary battery according to embodiments of the present disclosure.

According to some embodiments, a notch 520 may be formed on an outer circumferential surface of a side portion of a case 510. In addition, the notch 520 may surround the outer circumferential surface of the side portion of the case 510. The notch 520 may be formed as a continuous region (e.g., a continuous strip or ring shape) on the outer circumferential surface of the side portion of the case 510. The cross section of the notch 520 may have the shape of a semicircle 522. In addition, the cross section of the notch 520 may have the shape of a sharp wedge 524 that gradually becomes thinner or narrower in the direction of the surface close to the electrode assembly. The shape of the notch 520 is not limited to the semicircular shape of the wedge shape and may also be a V-shape, a U-shape, a spherical shape, or an inverted trapezoidal shape.

The position of the notch 520 includes a region corresponding to the side portions of the first and second electrodes disposed on the outermost side of the electrode assembly, and may be disposed in a location consisting of a range of ¼ of the total height of the case from the midpoint of the side portion of the case 510, considering the vertical bias of the electrode assembly and the alignment of the positive and negative electrodes. In addition, the depth of the notch 520 may be less than half the thickness of the side portion of the case 510, considering that the overall strength of the case 510 may be weakened.

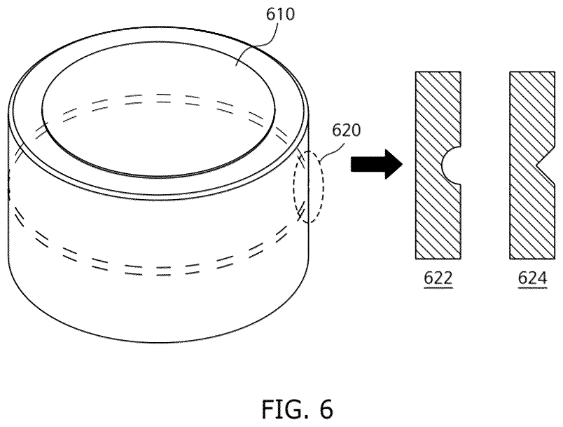

FIG. 6 illustrate a shape of a discontinuous notch according to embodiments of the present disclosure.

According to some embodiments, a notch 620 may be formed on an outer circumferential surface of a side portion of a case 610. In addition, the notch 620 may surround the outer circumferential surface of the side portion of the case 610. The notch 620 may be formed in a plurality of discontinuous positions or regions along the outer circumferential surface of the side portion of the case 610. For example, as illustrated in FIG. 6, the notch 620 may be formed in the form of a dashed line along the outer circumferential surface on the side portion of the case 610. Accordingly, the cross section of each of the notches 620 formed at a plurality of positions on the side portion of the case 610 may have the shape of a semicircle 622. Alternatively, the cross section of the notch 620 may have the shape of a sharp wedge 624 that gradually becomes thinner or narrower in the direction of the surface close to the electrode assembly. The shape of the notch 620 is not limited to the semicircular shape of the wedge shape and may also be a V-shape, a U-shape, a spherical shape, or an inverted trapezoidal shape.

The position of the notch 620 includes a region corresponding to the side portions of the first and second electrodes disposed on the outermost side of the electrode assembly, and may be disposed in a location consisting of a range of ¼ of the total height of the case from the midpoint of the side portion of the case 610, considering the vertical bias of the electrode assembly and the alignment of the positive and negative electrodes. In addition, the depth of the notch 620 may be less than half the thickness of the side portion of the case 610, considering that the overall strength of the case 610 may be weakened.

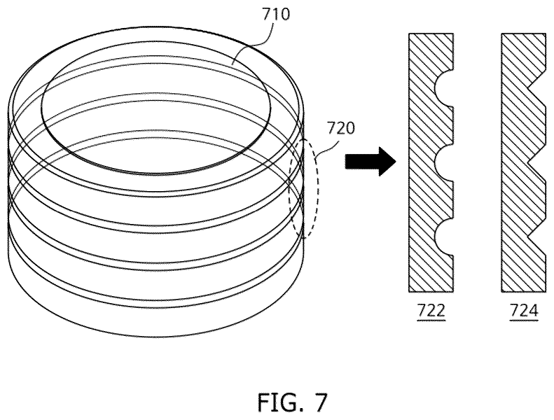

FIG. 7 illustrates a shape of a multi-notch according to embodiments of the present disclosure.

According to some embodiments, one or more notches 720 may be formed on an outer circumferential surface of a side portion of a case 710. The one or more notches 720 may surround the outer circumferential surface of the side portion of the case 710. Each of the one or more notches 720 may be formed in a continuous or discontinuous form along the outer circumferential surface of the side portion of the case 710. The one or more notches 720 may be disposed at regular intervals from the center of the entire height on the side portion of the case 710. For example, a first notch may be formed at the midpoint on the side portion of the case 710, and a second notch and a third notch may be formed at positions spaced downward or upward from the midpoint on the side portion of the case 710 at regular intervals. The cross section of each of the one or more notches 720 may have the shape of a semicircle 722. Alternatively, the cross section of the notch 720 may have the shape of a sharp wedge 724 that gradually becomes thinner or narrower in the direction of the surface close to the electrode assembly. The shape of the notch 720 is not limited to the semicircular shape of the wedge shape and may also be a V-shape, a U-shape, a spherical shape, or an inverted trapezoidal shape.

The position of the notch 720 includes a region corresponding to the side portions of the first and second electrodes disposed on the outermost side of the electrode assembly, and may be disposed in a range of ¼ of the total height of the case from the center of the case 710, considering the vertical bias of the electrode assembly and the alignment of the positive and negative electrodes. The one or more notches 720 may be disposed in a range of ¼ of the total height of the case at regular intervals. In addition, considering that the overall strength of the case 710 may be weakened, the depth of the notch 720 may be less than half the thickness of the side portion of the case 710.

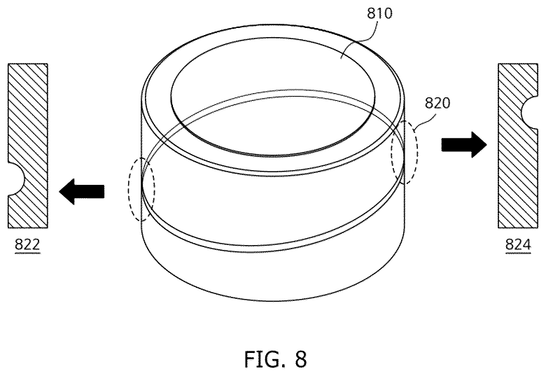

FIG. 8 illustrates an inclined notch according to embodiments of the present disclosure.

According to some embodiments, a notch 820 may be formed continuously or discontinuously along an inclined region on the outer circumferential surface of a case 810. The notch 820 may be formed to surround the outer circumferential surface of the side portion of the case 810 in an inclined shape. In FIG. 8, a notch 822 located on the left side of the case 810 (in the orientation shown) may be located below the midpoint of the overall height of the case 810. Meanwhile, a notch 824 located on the right side (in the orientation shown) of the case 810 may be located above the midpoint of the overall height of the case 810. The positions of the notches 822 and 824 respectively formed on the left and right sides of the case 810 include regions corresponding to the side portions of the first electrode and the second electrode disposed on the outermost side of the electrode assembly, and may be disposed in a range of ¼ of the total height of the case 810 from the midpoint of the side portion of the case 810, considering the vertical bias of the electrode assembly and the alignment of the positive and negative electrodes. In addition, the depth of the notch 820 may be less than half the thickness of the side portion of the case 810, considering that the overall strength of the case 810 may be weakened.

The cross section of the notch 820 may have the shape of a semicircle. In addition, the cross section of the notch 820 may have a sharp wedge shape that gradually becomes thinner or narrower in the direction of the surface close to the electrode assembly. The shape of the notch 820 is not limited to the semicircular shape of the wedge shape and may also be a V-shape, a U-shape, a spherical shape, or an inverted trapezoidal shape.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

What is claimed is:

1. A secondary battery comprising:
an electrode assembly configured to comprise a first electrode, a second electrode, and a separator disposed between the first electrode and the second electrode and wound therearound;
a case configured to have an opening formed on one side thereof to accommodate the electrode assembly; and
a cap assembly joined to the one side of the case to seal the opening of the case,
wherein the case comprises a notch formed on a side portion of the case.

2. The secondary battery as claimed in claim 1, wherein the notch is formed in a region of the side portion that corresponds to a side portion of the electrode assembly accommodated in the case.

3. The secondary battery as claimed in claim 2, wherein the notch is formed in a region of the side portion that corresponds to side portions of the first electrode and the second electrode disposed on an outermost side of the electrode assembly.

4. The secondary battery as claimed in claim 1, wherein the notch is formed in at least one position on an outer circumferential surface of the side portion.

5. The secondary battery as claimed in claim 1, wherein the notch is formed in a continuous region surrounding an outer circumferential surface of the side portion.

6. The secondary battery as claimed in claim 1, wherein the notch comprises a plurality of notches formed at a plurality of positions on a region surrounding an outer circumferential surface of the side portion.

7. The secondary battery as claimed in claim 1, wherein the notch is located in a position consisting of a range of ¼ of a total height of the case from a center of the side portion.

8. The secondary battery as claimed in claim 1, wherein a cross section of the notch has a semicircular shape.

9. The secondary battery as claimed in claim 1, wherein a cross section of the notch has a wedge shape.

10. The secondary battery as claimed in claim 1, wherein the notch is formed in a continuous region surrounding an outer circumferential surface of the side portion in an inclined shape.

11. The secondary battery as claimed in claim 1, wherein a depth of the notch is less than half a thickness of the side portion.

12. The secondary battery as claimed in claim 1, wherein a charging capacity of the electrode assembly falls within a range of 10 mAh to 150 mAh.

13. The secondary battery as claimed in claim 1, wherein a diameter of the case falls within a range of 9 mm to 14 mm.

14. The secondary battery as claimed in claim 1, wherein a height of the case falls within a range of 4.5 mm to 6 mm.

15. The secondary battery as claimed in claim 1, wherein the notch is configured to penetrate into an inside of the case in response to external pressure and come into contact with the first electrode or the second electrode.

16. The secondary battery as claimed in claim 1, wherein the notch is formed in a plurality of continuous regions surrounding an outer circumferential surface of the side portion.

17. A secondary battery comprising:
an electrode assembly configured to comprise a first electrode, a second electrode, and a separator disposed between the first electrode and the second electrode and wound therearound;
a cylindrical case configured to have an opening formed on one side thereof to accommodate the electrode assembly; and
a cap assembly joined to the one side of the cylindrical case to seal the opening of the case,
wherein the notch is formed in a region of the side portion of the cylindrical case that corresponds to a side portion of the electrode assembly accommodated in the case.

18. The secondary battery as claimed in claim 17, wherein the notch is configured to penetrate into an inside of the case in response to external pressure and come into contact with the first electrode or the second electrode.

19. The secondary battery as claimed in claim 17, wherein the notch is formed in at least one position on an outer circumferential surface of the side portion.

20. The secondary battery as claimed in claim 17, wherein the notch is located in a position consisting of a range of ¼ of a total height of the case from a center of the side portion.
